(19) United States
(12) Patent Application Publication
(10) Pub. No.: US 2013/0166515 A1
(43) Pub. Date: Jun. 27, 2013

(54) GENERATING VALIDATION RULES FOR A DATA REPORT BASED ON PROFILING THE DATA REPORT IN A DATA PROCESSING TOOL

(71) Applicants: David Kung, Cupertino, CA (US); Wu Cao, Redwood City, CA (US); Suryanarayana Mangipudi, San Ramon, CA (US); Aun-Khuan Tan, Sunnyvale, CA (US)

(72) Inventors: David Kung, Cupertino, CA (US); Wu Cao, Redwood City, CA (US); Suryanarayana Mangipudi, San Ramon, CA (US); Aun-Khuan Tan, Sunnyvale, CA (US)

(21) Appl. No.: 13/334,135

(22) Filed: Dec. 22, 2011

(51) Int. Cl. G06F 17/30

(52) U.S. Cl. 707/690; 707/E17.009

(57) ABSTRACT

In one embodiment, the method includes profiling a data file comprising one or more fields of data. The one or more fields of data contain an item of data; that is, a character, or group of characters that are related. Further, the method includes generating one or more profiling attributes based on profiling the data file. In an example, the one or more profiling attributes refer to profiling information relating to pattern, structure, content and format of data. Further, the method includes selecting at least one of the generated one or more profiling attributes and generating a validation rule based on the selected at least one profiling attribute.

### FIELD

The field relates generally to information processing tools. More specifically, the field relates to generating validation rules for a data report based on profiling the data report by an information processing tool.

### BACKGROUND

Modern businesses collect and handle large amounts of data during business operations such as production, sales, mergers, acquisitions, data migration, or simply data warehousing. To support efforts to store, process, and use this data, businesses have implemented data warehouses, which are large databases structured in a way that supports business decision-making However, many businesses have run into problems associated with having data of bad quality (e.g., incomplete, invalid, duplicative, erroneous, etc.) in the data warehouses. In order to assess the quality of data in data records, validation rules may be applied to the data records to determine data records that have column or field values that deviate from the values that are expected by the rules.

Conventionally, a user may use a rule editor user interface to create new data rules or modify existing rules. The user may then save the rules in a rule repository in the rule language or in a common rule format. The user may then select rules from the rule repository and a set of data records to execute the selected rules against the selected data records to validate the data. However, developing data rules in said manner requires a significant amount of user time, effort and skill to analyze patterns in data, especially for large data sets having millions of records with hundreds of columns. Also, it is a tedious task to design data rules for records that have non-repeatable values. For example, if the values in the analyzed columns are unique (in the case of a phone number for instance) or have a very high cardinality (in the case of the ZIP code for instance), then all possible rules may have to be manually created for the values of such columns.

### SUMMARY

Various embodiments of systems and methods for generating validation rules for a data report based on profiling the data report by an information processing tool are described herein. In an aspect, the method for generating validation rules for a data report involves profiling a data file comprising one or more fields of data. The one or more fields of data contain an item of data; that is, a character, or group of characters that are related. For instance, a grouping of characters such as “95110” makes up a postal code field. Further, in an aspect, the method includes generating one or more profiling attributes based on profiling the data file. In an example, the one or more profiling attributes refer to profiling information relating to a pattern, structure, content, and format of data. In an aspect, the method includes selecting at least one of the generated one or more profiling attributes and generating a validation rule based on the selected at least one profiling attribute.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like reference numerals indicate similar elements. The embodiments of the invention, together with its advantages, may be best understood from the following detailed description taken in conjunction with the accompanying drawings.

FIG. 1 is a flow diagram of a method generating validation rules for a data report, according to one embodiment.

FIG. 2 illustrates a block diagram of an exemplary system for generating validation rules for a data report configured in accordance with an embodiment.

FIG. 3 illustrates a graphical user interface displaying profiling statistics of a report in accordance with an embodiment.

FIG. 4 illustrates a graphical user interface displaying a generated validation rule in accordance with an embodiment.

FIG. 5 illustrates a block diagram of an exemplary computer system configured in accordance with an embodiment.

### DETAILED DESCRIPTION

Embodiments of techniques for generating validation rules for a data report based on profiling the data report by an information processing tool are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

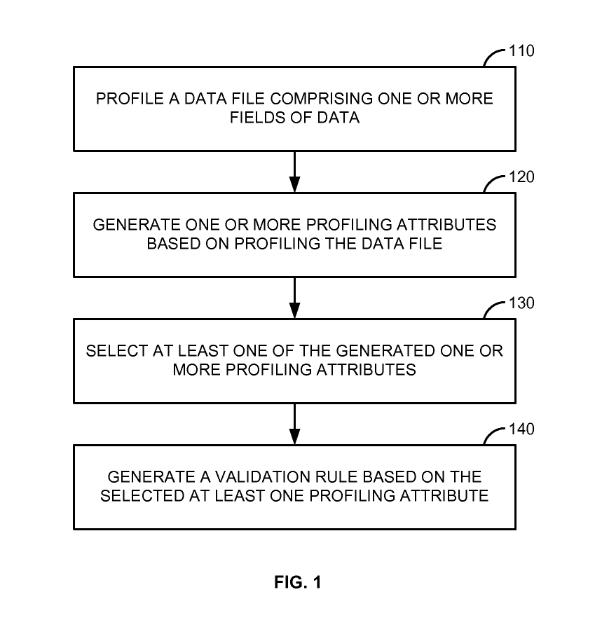

FIG. 1 illustrates a flow diagram of a method 100 for generating validation rules for a data file, according to one embodiment. The method includes profiling (110) a data file comprising one or more fields of data. The data file is composed of a group of related fields of data. For example, a payroll data may contain the name, address, social security number, and title of each employee as fields in the report. The term “data profiling” as used herein, also referred to as data discovery, is the process of examining data sources such as a database or data residing in any file structure and collecting statistics and information about that data. The purpose of this profiling may be to: determine the structure, content, relationships and derivation rules of the data; improve the ability to search the data by tagging it with keywords, descriptions, or assigning it to a category; assess the risk involved in integrating data for new applications, including the challenges of joins; assess whether metadata accurately describes the actual values in the source database; validate metadata when it is available and discover metadata when it is not available.

Data profiling process also helps understand anomalies in the data by deciphering data patterns and formats, and identifying redundant data across data sources. The term “anomalies” as used herein refers to a deviation from an expected order or form, or rule. For example, profiling techniques for data completeness indicate whether all records that should be there are there and that none of their fields are blank. They can also uncover the existence of duplicate records. Besides providing metrics on data anomalies, an efficient data profiling process can assist in key data management processes including Master data management and data governance by way of assessing metadata. For example, the data profiling process involves, use of analytical and statistical tools to outline the quality of data structure and data organization by determining various frequencies and ranges of key data element within data sources; applying Numerical analysis techniques to determine the scope of numeric data within data sources; identifying multiple coding schemes and different spellings used in the data content; identifying data patterns and data formats and making note of the variation in the data types and data formats being used within data sources; identifying duplicity in the data content such as in name, address or other pertinent information; and deciphering and validating redundant data within the data sources.

In an embodiment, data profiling is performed during a data warehouse development process to ensure that a required data is available at a required level of detail. The data reports may be received by the computer from one or more data source systems or any other computer on the network. For example, data received at the computer may be collected from data source systems such as databases, external feeds, data ware houses, datamarts, etc. For example, a report obtained at the computer may contain one or more tables of data, where each table is comprised of one or more fields of data. The fields may be characterized as row or column in the table and each field may contain one or more data elements such as a string of characters, numerals, alphabets, or any combination. The data from the source data system may be subject to several intermediate transformations and integrations prior to being populated in the report. Also, the data in the report may be obtained from multiple disparate data sources each having varying degrees of reliability.

Referring back to FIG. 1, the method includes generating (120) one or more profiling attributes based on profiling the data file. Examples of the one or more profiling attributes include but are not limited to: 1) variation of numerical values such as minimum, maximum, average, and median values; 2) distinct lengths of string values in a column and the percentage of rows in the table that each length represents. Example: Profile of a column of US State codes, which should be two characters, shows values longer than 2 characters; 3) percentage of null or blank values in a column. Example: Profile of a ZIP code/postal code column shows a high percentage of missing codes; 4) percentage of regular expressions that occur in a column. Example: A pattern profile of a phone number column shows numbers entered in three different formats: (919)674-9945, [919]6749988, and [919]361-8748; 5) minimum, maximum, average, and standard deviation for numeric columns and minimum and maximum for date/time columns. Example: Profile for an Employee birth date column shows the maximum value is in the future; 6) distinct values in a column and percentage of rows in the table that each value represents. Example: A profile of a U.S State column contains more than 50 distinct values; 7) candidate key column for a selected table. Example: Profile shows duplicate values in a potential key column; 8) dependency of values in one column to values in another column or columns. Example: Profile shows that two or more values in the State field have the same value in the ZIP code field; and 9) value inclusion between two or more columns. Example: Some values in the ProductID column of a Sales table have no corresponding value in the ProductID column of the Products table.

The method further includes selecting (130) a profiling attribute from the generated one or more profiling attributes and generating (140) a validation rule based on the selected profiling attribute. A validation rule is a criterion used for determining whether data in a data file falls within required or specified parameters. The parameters may be defined by a systems analyst or the like. The validation rule may also limit or control what data can be entered in a table field. Examples of the various types of validation rules include data type validation rule, field size validation rule, table properties validation rule, input mask validation rule, field validation rule, record validation rule, etc. For example, by applying a data type validation rule, a Date/Time field accepts only dates and times, a Currency field accepts only monetary data, and so on. By applying a field size validation rule, a field that stores first names can be set to accept a maximum of 20 characters. Using table properties validation rule, a “Required” property can be set to “Yes” so as to force users to enter a value in the given field. Input mask validation rule may be used to force users to enter data in a specific format, e.g., a European date format such as 2011. 12. 25. The field validation rule may be used to ensure that the value entered in a field satisfies a certain rule bound to that field. For example, the field validation rule for a Date field may be set by a rule in the Validation Rule property of that field. Such a rule may be an equality or inequality with respect to a certain date. For example, the rule entered in could be expressed as >=#01/01/2007#. The rule requires users to enter dates on or after Jan. 1, 2007. The record validation rule may be used to control the value entered in a field of the table with reference to the values entered in other fields of the same table. Comparison operators and other operators may be used to express the rule. For example, if a business requires that the products be shipped within 30 days from the date of order, the record validation rule may be defined as [ShipDate]<=[OrderDate]+30 to ensure that the shipping date entered in the ShipDate field is less than 30 days from the date value received in the OrderDate field.

In an embodiment, selecting at least one of the one or more profiling attributes includes selecting a particular pattern or format from the profiling statistics. The profiling statistics are received as a result of profiling the data file and pertain to attributes of the data in the data file such as distribution of data, patterns, min. value, and max. value, format, etc. In response to receiving a selection of a profiling attribute, the method includes automatically generating a validation rule based on the selected profiling attribute. In an embodiment, the profiling statistics may be provided in a table as shown in Table 1 below, and a selection of a profiling attribute may be indicated by e.g., “clicking” the attribute of interest and selecting a “create rule” option on a graphical user interface. In response to receiving a selection for creating a rule, a validation rule is generated based on the selected attribute. For example, the profiling statistics for a data file may reveal two or more patterns of values for Social Security Number. A validation rule may be created based on selecting one of the two or more patterns of values for the Social Security Number which may be a preferred pattern or valid pattern. More than one attribute may be selected and a complex validation rule is created using the selected attributes. For example, the profiling statistics for a social security number field may include “Blank” fields and more than one pattern for values, e.g., “**_****_**,” “****_****,” and “***_**_***.” A validation rule such as “$SSN is NOT NULL,” AND “$SSN has pattern ‘***_**_***’” may be created in response to receiving a selection of attributes “Blank” field and pattern “***_**_***” for the social security number. Therefore, binding the validation rule to a field may not allow a field to be left blank and may not accept any other pattern other than “***_**_***” for a social security number. Also, the generated rule for SSN may be applied to a field that already has a set of data in order to identify those values that do not fulfill the generated rule.

TABLE 1

| Category | Attribute | Data Type |
|---|---|---|
| Value | Min | Number |
| | | Varchar |
| | | Date/Time |
| | Max | Number |
| | | Varchar |
| | | Date/Time |
| | Average | Number |
| | | Varchar |
| | | Date/Time |
| | Median | Number |
| | | Varchar |
| | | Date/Time |
| String Length | Min | Varchar |
| | Max | Varchar |
| | Average | Varchar |
| | Median | Varchar |
| Completeness | Null | All |
| | Blank | Varchar |
| | Zero | Number |
| Distribution | Data | Number |
| | | Varchar |
| | | Date/Time |
| | Pattern | Varchar |

An example of the profiling statistics generated by profiling a data file is shown in Table 1. In the given example, Table 1 includes fields Category, Attribute, and Data Type. The Category field provides a general profiling category for the attributes pertaining to data contained in the data file that is profiled. In the given example, the category includes Value, String length, Completeness, and Distribution. The attributes under Value category and String length category include Min value, Max value, Average value, and Median value. The attributes under Completeness category include Null, Blank, and Zero. The attributes under Distribution category include Data and Pattern. Table 1 includes a Data Type column providing the data type covered by each attribute such as Number, character “Varchar”, and Date/time. Selecting any attribute from the attributes listed in Table 1, automatically generates a corresponding validation rule as shown in Table 2.

TABLE 2

| Category | Attribute | Data Type | Validation Rule |
|---|---|---|---|
| Value | Min | Number | $param >= attr_value |
| | | Varchar | $param >= ‘attr_value’ |
| | | Date/Time | $param >= to_date(‘attr_value’, ‘format’) |
| | Max | Number | $param <= attr_value |
| | | Varchar | $param <= ‘attr_value’ |
| | | Date/Time | $param <= to_date(‘attr_value’, ‘format’) |
| | Average | Number | $param >= attr_value |
| | | Varchar | $param >= ‘attr_value’ |
| | | Date/Time | $param >= to_date(‘attr_value’, ‘format’) |
| | Median | Number | $param >= attr_value |
| | | Varchar | $param >= ‘attr_value’ |
| | | Date/Time | $param >= to_date(‘attr_value’, ‘format’) |
| String Length | Min | Varchar | length($param) >= attr_value |
| | Max | Varchar | length($param) <= attr_value |
| | Average | Varchar | length($param) = attr_value |
| | Median | Varchar | length($param) = attr_value |
| Completeness | Null | All | $param is not null |
| | Blank | Varchar | Length($param) >= 1 |
| | Zero | Number | $param != 0 |
| Distribution | Data | Number | $param in (value 1, value2, . . .) |
| | | Varchar | $param in (‘value1’, ‘value2', . . .) |
| | | Date/Time | Format(Date($param),“mmm dd, yyyy”) |
| | Pattern | Varchar | match_pattern($param, ‘pattern1’) OR |
| | | | match_pattern($param, ‘pattern2’) |

The validation rules shown in TABLE 2 are created in the form of expressions composed of a combination of functions, identifiers, operators, and constants. In the validation rule examples given in Table 2, “$param,” “value1,” “value2,” are identifiers; “>=” (greater than or equal to), “!=” (not equal to), and “<=” (less than or equal to) are operators; “match_pattern” “date,” “format,” and “Length” are functions; and “1” and “0” are constants. In an example, selecting an attribute such as “Blank” under the Completeness Category generates a rule such as Length($param)>=1, such that the rule expression returns True when it is applied to a parameter string having a length that is greater than or equal to 1 and returns False when it is applied to a parameter string of length less than 1, i.e. a blank field. This rule expression can be applied to a table field to ensure that only positive values are entered. In another example, an order number field may have a range of order numbers from 100-900, the Min profile attribute under “Value” category for data type “Number” would be 100, and Max profile attribute would be 900. A rule such as “$param >=attr_value” as show in TABLE 2 may be generated based on selecting the Min profile attribute value 100. The generated validation rule would then be “$param >=100” i.e., the value of a parameter provided in a particular field should be greater than or equal to 100.

Similarly, selecting an attribute “Zero” having data type “Number” may generate a validation rule expressed as “$param !=0.” Applying a rule expression “$param !=0,” to a value identified by the identifier “$param” returns True when it is compared to a number that is not zero. The validation rule may be applied to data already provided in a table or to data imported into the table. The rule expression “Format(Date($param), “mmm dd, yyyy”)” may be used to format a date value in a variety of ways. Format “mmm” specifies that the month name is spelled out upto 3 characters; “dd” specifies that the day is displayed with 2 digits, and “yyyy” specifies that the year is displayed with 4 digits. For example, on 2/8/2006 this expression would return “Oct. 21, 2010.”

In an embodiment, the method includes automatically generating an optimal validation rule based on the data type. For example, in response to receiving a selection of attribute “blank,” the method includes determining whether the data type is “Number” or “Character.” If it is determined that the data type is Number, the validation rule may be generated based on the function “value greater than or equal to 1.” Otherwise, if it is determined that that data type is Character, the validation rule may be generated based on the function “String length greater than or equal to 1.” Further, the method includes binding the generated validation rule to a field or column. For example, the validation rule generated based on the profiling results for a particular field may be bound to that particular field. The validation rule may also be bound to other fields in the record for which the validation rule may apply. The values provided in the field or column may be validated against the validation rule that is bound to the field or column.

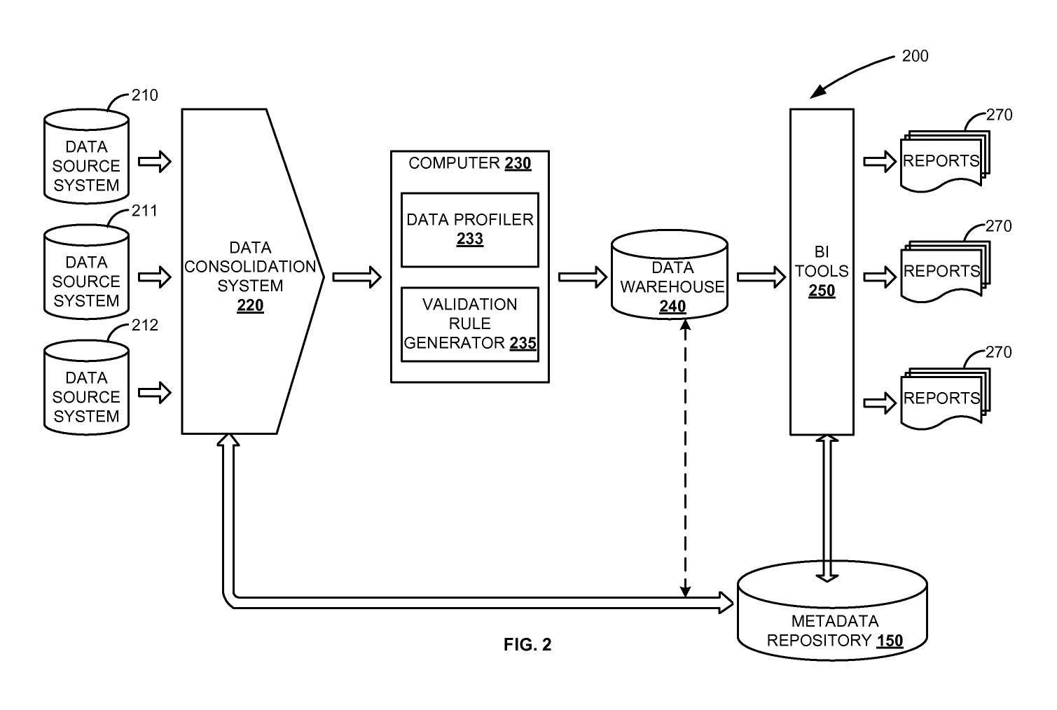

FIG. 2 illustrates a system 200 configured to perform the method described with reference to FIG. 1, in accordance with an embodiment of the invention. The system 200 includes a set of data source systems 210, 211, and 212, data consolidation system 220, a computer 230, data warehouse 240, Business Intelligence (BI) tools 250, and a metadata repository 260 operating in a data communication network. A data source system 210, 211, or 212 is an information resource. Data source systems 210, 211, and 212 include sources of data that enable data storage and retrieval. Data source systems 210, 211, and 212 may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files), hierarchical data (e.g., data in a file system, XML data), files, a plurality of reports 270, and any other data sources accessible through an established protocol, such as, Open DataBase Connectivity (ODBC), produced by an underlying software system (e.g., Enterprise Resource Planning (ERP) system), and the like. Data source systems 210, 211, and 212 may also include a data source where the data is not tangibly stored or otherwise ephemeral such as data streams, broadcast data, and the like. These data source systems 210, 211, and 212 can include associated data foundations, semantic layers, management systems, security systems and so on.

By way of example, the data source systems 210, 211, and 212 may include databases, external feeds, data ware houses, datamarts, modeling tools, ETL tools, Business Intelligence (BI) tools, and the like. Data consolidation systems 220 such as ETL, EAI, and ELT coordinate the retrieval and delivery of metadata from the disparate data source systems 210, 211, and 212 to the metadata repository 260. Also, the data in the data source systems 210, 211, and 212 are subject to data transformation and integration through the data consolidation system 220 and loaded into the data warehouse 240. The data in the data warehouse 240 may be accessed by Business intelligence (BI) tools 250 to create and supply one or more reports 270. The BI tools 250 include executable instructions required to turn the data into information such as standard reports, queries, analytical applications, OLAP analysis, exception based reporting, data mining etc. The one or more reports 270 may be rendered on the computer 240 in the network.

The computer 230 includes a computer readable storage medium (CRSM) having executable instructions or code stored therein to perform the above-illustrated methods. For example, the CRSM includes a data profiler 233 and a validation rule generator 235 comprising executable instructions to coordinate the processing of the information received at the data warehouse 240, and the metadata repository 260. Based on the instructions, the processor performs operations including, but not limited to, profiling a data file comprising one or more fields of data, generating profiling attributes based on profiling the data file, selecting a profiling attribute from the generated profiling attributes, and generating a validation rule based on the selected profiling attribute. The data profiler 233 includes executable instructions to perform profiling operations on data received from the one or more data source systems. Based on the instructions from the data profiler, a processor associated with the computer 230 executes a profiling program to identify and characterize the pattern and format of data distributed in the fields of a record. The terms record, data file, database, report, and table may be used interchangeably throughout the description and refer to any file structure containing data that is retrieved, in response to computer executable instructions, from a data source system, where the information is structured in accordance with a report schema that specifies the form in which the information should be presented.

Further, in response to receiving a selection of a profiling attribute from the profiling results provided by the data profiler, the validation rule generator 235 creates validation rules based on the selected profiling attribute. In an embodiment, the profiling results i.e., profiling statistics regarding the data contained in the data file is rendered on a graphical user interface (GUI) of the computer 230. The profiling statistics may include information such as a name of the table, fields, profiling category, attributes, and data types. A profiling attribute may be selected from the profiling statistics rendered on the GUI by, for example, operating a selection key or dedicated button on an input interface of the computer 230. In another example, a profiling attribute may be selected using a voice command or an audio input. Upon receiving a selection for a profiling attribute, the processor automatically generates a validation rule and renders the validation rule on the GUI.

In an embodiment, the processor automatically generates an optimal validation rule based on determining a data type of the selected profiling attribute. For example, in response to receiving a selection of attribute “blank,” for a particular field, the processor determines whether the data type is “Number” or “Character.” If it is determined that the data type is Number, the processor generates a validation rule based on a function e.g., “value greater than or equal to 1.” Otherwise, if it is determined that that data type is Character, the processor generates a validation rule based on a function “String length greater than or equal to 1.” The generated validation rule may be further edited or tested by a user using the input interface of the computer 230. In an aspect, the generated validation rule is bound to the field (row/column) of the record that is profiled by the data profiler 233. The automatically generated validation rule may be edited or altered by a user at a later time. For example, the validation rules may be applied to another field or table having a data set that is different from that which was profiled. The validation rules may then be adapted for the current set of data and used for validating the data in the current set of data.

In an embodiment, the data file is validated using the generated validation rules in order to derive a data quality score for the data file. For example, the data quality score may indicate a degree of accuracy of data, where higher the data quality score, better the accuracy of data in the record. The data quality score may be stored in the metadata repository or the data warehouse 240 along with the data. In an embodiment, the data quality scores, in the form of metadata, are directed to the metadata repository 260. The data quality scores may be downloaded from the metadata repository 260 for further processing.

Further, the validation rule generator may assign weights to each of the generated validation rules, according to a weight definition and then determine a data quality score for the data file based on the weighted validation rules. The composition and weighting of the generated validation rules is configurable. In addition, the weighting of profiling attributes used for forming a validation rule is configurable. For example, more weight may be ascribed to profiling attributes that represent key quality conformant for a given organization. That is, an organization can customize validation rules within a system to reflect an organization's internal values, priorities, weightings, and thresholds with respect to validating the quality of data.

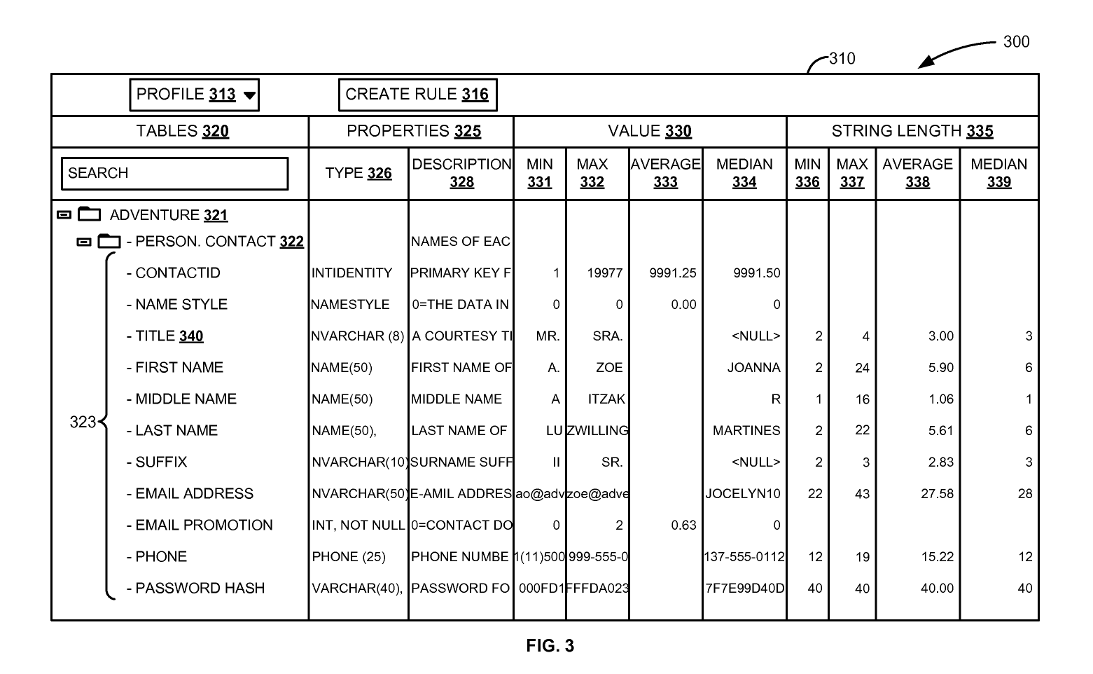

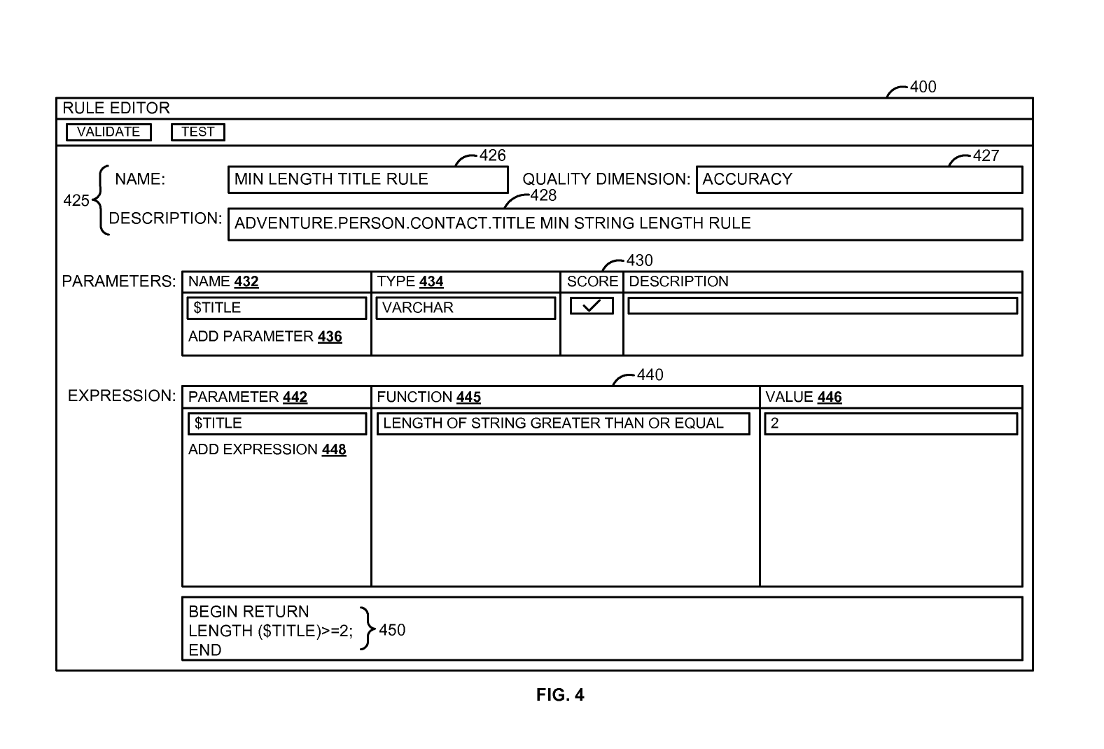

FIG. 3 illustrates an exemplary graphical user interface 300 showing a graphical representation of the profiling statistics pertaining to data in a data file. In the given example, the profiling statistics for the data file is provided in a workspace panel 310 on the GUI of the computer 230. The panel 310 includes control tabs 313 and 316 for performing a “Profile” operation and “Create Rule” operation. Further, the panel 310 includes blocks representing the profiling metrics such as data types, patterns, formats, and values of the data in the data file that is profiled. In the given example, the blocks 320, 325, 330, and 335 represent Tables, Properties, Value, and String length. The column represented by the Tables block 320 shows the various fields 323 of table 322 “Person.contact” of a record 321 “Adventure.” Examples of the fields 323 belonging to the table 322 “person.contact” include contactID, NameStyle, Title, FirstName, Middle Name, LastName, Suffix, EmailAddress, EmailPromotion, Phone, and PasswordHash. The column represented by the Properties block 325 includes attributes “Type” 326 and “Description” 328. The information provided under the Type attribute 326 represents a data type of the corresponding field and the information provided under the Description attribute 328 provides a description of the fields 323 of the table 322 “Person.contact.” The column represented by the Value block 330 includes attributes “Min” 331, “Max” 332, “Average” 333, and “Median” 334. The values under each of the Value attributes 331, 332, 333, and 334 provide information regarding the actual minimum, maximum, average, and standard deviation values for numerical values and strings. The column represented by the String Length block 335 includes attributes “Min” 336, “Max” 337, “Average” 338, and “Median” 339. The values under each of the String Length attributes 336, 337, 338, and 339 provide information regarding the minimum, maximum, average, and standard deviation values of the string length of the actual values provided under Values column. In the given example, the value of “2” under the Min string length attribute 336 for Title field 340 is selected, as shown highlighted in FIG. 3. Based on the selection, the processor automatically generates a validation rule for the Title field 340 using the selected minimum string length value of “2” as the function for creating the rule. The processor then binds the generated validation rule to the corresponding Title field and renders the generated validation rule on a rule editor interface as shown with reference to FIG. 4.

As shown in FIG. 4, a Rule Editor interface 400 is displayed on the GUI subsequent to generating the validation rule. The Rule Editor interface 400 includes a Validate tab 415 for validating the syntax of the generated rule and a Test tab 420 for testing the generated validation rule. The Rule Editor interface 400 further includes a panel 425 having fields 426, 427, and 428 for receiving a name for the rule, a quality dimensions for the rule, and a description for the generated rule. In the given example, “Min Length Title Rule” is received as the name of the generated rule in the name field 426. “Accuracy” is received as the quality dimension in the Quality dimension field 427, and “Adventure_Person.Contact_Title_Min String Length_Rule” is received as the description of the rule in the Description field 428. In an aspect, the above information may be automatically rendered in the associated fields 426, 427, or 428 based on the selected profiling attribute. The Rule Editor interface 400 further includes a Parameters panel 430 having details of the field to which the generated validation rule is bound. In the given example, the Parameters panel 430 is auto-populated with the field name and data type information pertaining to the selected profiling attribute. Additional parameters may be added using the Add Parameter option 436. The Rule Editor interface 400 further includes an Expression panel 440 to add or edit the expression around the parameter 442 to which the generated validation rule is bound, the underlying function 445 for creating the validation rule, and the value 446 of the selected profiling attribute. In the given example, the $Title is shown as the parameter to which the generated validation rule is bound and “length of string greater than or equal” as the function defining the validation rule, and the value of “2” as the metric for the function. The Expression panel 440 may display the validation rule expression 450 in a validation program. In the given example, the validation rule is represented by the expression “length($Title)>2.” The generated validation rule that is displayed in the Rule Editor interface may be subject to modifications. Additional expressions may be added using the Add Expression option 448.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

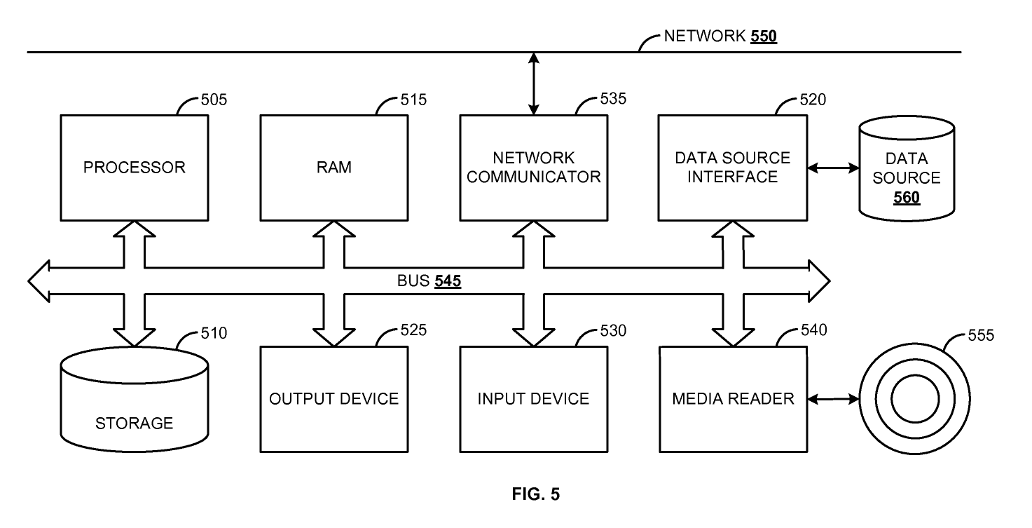

FIG. 5 is a block diagram of an exemplary computer system 500. The computer system 500 includes a processor 505 that executes software instructions or code stored on a computer readable storage medium 555 to perform the above-illustrated methods. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and application software such as ERP and Customer Relationship Management (CRM) systems where data is accessed via application specific native interfaces.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

1. A computer-implemented method, comprising:
profiling a data file comprising one or more fields of data;
generating statistics pertaining to attributes of the data in the data file, based on the profiling;
selecting at least one data attribute from the generated statistics; and
generating a validation rule based on the selected at least one data attribute.

2. The method of claim 1, wherein profiling the data file comprising one or more fields of data comprises examining the data comprised in the data file to determine at least a pattern and format of the data.

3. The method of claim 1, wherein generating the statistics based on profiling the data file comprises generating statistics relating to anomalies present in the data.

4. The method of claim 1, wherein generating the validation rule based on the selected at least one data attribute comprises automatically creating a validation rule as a function of the selected at least one data attribute.

5. The method of claim 4, wherein the validation rule is generated based on identifying a data type associated with the selected at least one data attribute.

6. The method of claim 1 further comprising binding the generated validation rule to the one or more fields of data.

7. An article of manufacture, comprising:
a non-transitory computer readable storage medium having instructions which when executed by a computer causes the computer to:
profile a data file comprising one or more fields of data;
generate statistics pertaining to attributes of the data in the data file, based on the profiling;
select at least one data attribute from the generated statistics; and
generate at least one validation rule based on the selected at least one data attribute.

8. The article of manufacture in claim 7, wherein the at least one validation rule is defined as a function of at least one of a max-min value of a field, a max-min length of a field, a character type of a field, a pattern of a field, a distribution of a field, a blank field, and a content of a field.

9. The article of manufacture in claim 7, wherein profiling the data file comprising one or more fields of data comprises examining the data comprised in the data file to determine a structure and content of the data.

10. The article of manufacture in claim 7, wherein generating the statistics based on profiling the data file comprises generating statistics relating to anomalies present in the data.

11. The article of manufacture in claim 7, wherein generating the validation rule based on the selected at least one profiling data attribute comprises automatically creating a validation rule as a function of the selected at least one data attribute.

12. The article of manufacture in claim 11, wherein the validation rule is generated based on identifying a data type associated with the selected at least one data attribute.

13. The article of manufacture in claim 7, further comprising instructions for binding the generated validation rule to the one or more fields of data.

14. The article of manufacture in claim 7, further comprising instructions for generating a data quality score for the data file based on applying the validation rules to the one or more fields of data.

15. A system operating in a communication network, comprising:
a data source system holding a data file; and
a computer comprising a memory to store a program code, and a processor to execute the program code to:
profile the data file received from the data source system,
generate statistics pertaining to attributes of the data in the data file, based on the profiling,
select at least one data attribute from the generated statistics, and
generate at least one validation rule based on the selected at least one data attribute.

16. The system of claim 15, wherein the generated statistics relate to at least one of a max-min value of a field, a max-min length of a field, a character type of a field, a pattern of a field, a distribution of a field, a blank field, and a content of a field.

17. The system of claim 15, wherein the at least one validation rule is defined as a function of at least one of a max-min value of a field, a max-min length of a field, a character type of a field, a pattern of a field, a distribution of a field, a blank field, and a content of a field.

18. The system of claim 15, wherein the at least one data source system includes one of a web service, a data warehouse, a database, an integrated ERP system, or an external database.

19. The system of claim 15, wherein the data file is composed of a group of related fields of data.

20. The system of claim 15, wherein the data comprised in the data file include one of a character string, numeric value, or alpha-numeric string.
